(19) United States
(12) Patent Application Publication
(10) Pub. No.: US 2025/0061474 A1
(43) Pub. Date: Feb. 20, 2025

(54) Interactive Map

(71) Applicant: William D. Mixon, Anna Maria, FL (US)

(72) Inventor: William D. Mixon, Anna Maria, FL (US)

(21) Appl. No.: 18/536,069

(22) Filed: Dec. 11, 2023

Related U.S. Application Data
(63) Continuation-in-part of application No. 16/936,156, filed on Jul. 22, 2020, now Pat. No. 11,947,769.
Application No. 16/936,156 is a continuation-in-part of application No. 15/985,602, filed on May 21, 2018, now Pat. No. 10,733,216.
(60) Provisional application No. 62/509,236, filed on May 22, 2017.

(51) Int. Cl. G06Q 30/0201; G06F 3/0481; G06Q 50/00; H04L 67/306

(52) U.S. Cl. CPC G06Q 30/0201; G06F 3/0481; G06Q 50/01; H04L 67/306

(57) ABSTRACT

The present disclosure provides a system that collects customer data in a way that creates a shared experience. More specifically, an interactive map for customer engagement is provided. In some embodiments, this information may be displayed at the establishment for other customers to view. This system and method may receive and save addresses to show where customers may originate from. Displaying an interactive map may allow a company to gather data from their customers while engaging the customers in a social sharing platform. This may increase the likelihood that a customer may provide the data and increase a sense of community within a customer pool.

### CROSS-REFERENCE TO RELATED APPLICATION

This application is a Continuation in Part of and claims priority to and the full benefit of U.S. Non-Provisional patent application Ser. No. 16/936,156 (filed Jul. 22, 2020 and titled “INTERACTIVE MAP”), which claimed priority to and the full benefit of U.S. Nonprovisional patent application Ser. No. 15/985,602 (filed May 21, 2018 and titled “INTERACTIVE MAP”), which claimed priority to and the full benefit of U.S. Provisional Patent Application Ser. No. 62/509,236 (filed May 22, 2017 and titled “INTERACTIVE MAP”), the entire contents of which are incorporated in this application by reference.

### BACKGROUND OF THE DISCLOSURE

The advent of the internet has facilitated different ways for companies to measure their performance as well as the reach of their brands or experience. For example, a consumer may use a search engine to find a location, see how it has been rated, and compare these ratings or the location to whatever people in their social spheres do. Companies can run analytics to measure how they are performing in the market and tweak their messaging accordingly. Consumers can make more informed decisions as to how and where they want to spend their time.

As a company's reach grows exponentially, so too does the need to capture each consumer's information. Customer resource management provides a small piece for companies to maintain contact with a consumer after they visit their location, when they make a purchase, or when they sign up to be part of continued contact, such as a mailing list. However, there exists a need to capture a consumer's information at an establishment that streamlines the process while creating a social aspect for other consumers.

Further, community support and sharing have now become an essential part of reaching, acquiring, and keeping new customers. Social media has become prolific and a desire to share experiences with a community has become the norm. Currently, the majority of ways to share an experience occur on popular social media platforms.

### SUMMARY OF THE DISCLOSURE

What is needed are systems and methods for an establishment that may intake a customer's information and allow customers to feel like they are sharing their experience with a community. Accordingly, the present disclosure relates to a system that collects customer data in a way that creates and fosters a shared experience. In some embodiments, this information may be displayed at the establishment for other customers to view. More specifically, an interactive map for customer engagement is provided.

In some implementations, these inputs may be set by the establishment. In some aspects, the customer may receive correspondence based on their interests or data input. This system or method may receive and save addresses to show where customers may originate from. Displaying an interactive map may allow a company to gather data from their customers while engaging the customers in a social sharing platform. This may increase the likelihood that a customer may provide the data and increase a sense of community within a customer pool. As more customer information is received, the system or method may streamline the data that is displayed so that it is easier for other customers to navigate or add their information.

In some cases, an establishment may receive hundreds of data inputs, and the interactive map may allow customers to view the data inputs in an engaging manner, such as by providing sort, filter, and preference options. In some embodiments, the system or method may determine the most relevant input that may appeal to the customers of the establishment. In some implementations, the establishment may determine what to display based on a standardized input, customer feedback, or expectation as to how many people may be providing their information on a daily basis. The system or method may provide different views based on daily, weekly, monthly, quarterly, or yearly inputs.

One general aspect of the present disclosure may comprise a system for providing an interactive map. The system may comprise a display; one or more local input interfaces; one or more memory resources may comprise: a user profile database; one or more processors in communication with the display, one or more local input interfaces, and the one or more memory resources, wherein the one or more processors are configured to receive one or more sets of pin data, wherein each set of pin data may comprise at least one location; identify a pin area for each of the one or more sets of pin data; define one or more geofence boundaries based on each pin area; display an interactive map on the display; display at least one pin within the pin area of each of the one or more sets of pin data on the interactive map; and receive at least a portion of the one or more sets of pin data from at least one external computing device. Embodiments of this aspect may include corresponding computer systems, apparatus, and computer programs recorded on one or more computer storage devices, each configured to perform the actions of the methods.

Implementations may comprise one or more of the following features. In some aspects, the one or more processors may be further configured to: receive a manual location selection; define a selection set of geofence boundaries based on the manual location selection; and display one or more the first plurality of pins located within the selection set of geofence boundaries. In some embodiments, the selection set of geofence boundaries may be based on a threshold number of pins located within the selection set of geofence boundaries. In some implementations, a size of each pin may be based on a quantity of the first plurality of locations within the selection set of geofence boundaries. The first set of geofence boundaries may be based at least in part on city limits of each of the plurality of locations.

In some aspects, the one or more processors may be further configured to: receive a second set of pin data may comprise a second plurality of locations; define a second set of geofence boundaries based on the second plurality of locations; define a second local map may comprise at least the second set of geofence boundaries, wherein defining compares the second set of geofence boundaries to standard map boundaries; define a third set of geofence boundaries based on comparing the first local map to the second local map identify a second pin area, wherein the third set of geofence boundaries contain both the first set of geofence boundaries and the second set of geofence boundaries; and define a second local map may comprise at least the third set of geofence boundaries, wherein defining compares the third set of geofence boundaries to standard map boundaries.

In some implementations, the one or more processors may be further configured to: display a second interactive map may comprise the second local map; and display a second plurality of pins based on the first plurality of locations and the second plurality of locations on the second local map. The one or more processors are further configured to: compare the first plurality of locations to the second plurality of locations, wherein the comparing identifies a proximity between each of the first plurality of locations and each of the second plurality of locations; and define a plurality of pin geofence boundaries of the second plurality of pins based on the comparing of the first plurality of locations to the second plurality of locations, wherein the defining occurs where the proximity is less than a predefined threshold distance, and wherein display of the second plurality of pins may comprise a pin for each of the plurality of pin geofence boundaries.

In some aspects, the system of the present disclosure may comprise at least one external computing device communicatively coupled to the one or more processors, wherein the external computing device may comprise at least one input device, at least one storage medium, and at least one processing device, wherein the storage medium may comprise one or more coded instructions that enable the processing device to receive at least a portion of the one or more sets of pin data and transmit the at least a portion of the one or more sets of pin data to the one or more processors of the system.

In some embodiments, a size of each pin is based on a quantity of the first plurality of locations and the second plurality of locations within each of the plurality of pin geofence boundaries. The one or more processors may be further configured to: associate one or more pin type with the first plurality of pins, wherein display of each of the first plurality of pins is displayed according to at least one of the one or more pin types. Implementations of the described techniques may include hardware, a method or process, or computer software on a computer-accessible medium.

One general aspect of the present disclosure may comprise a method for displaying an interactive map. The method may comprise receiving a first plurality of sets of pin data may comprise a first plurality of locations; defining a first set of geofence boundaries based on the first plurality of locations; defining a first local map may comprise at least the first set of geofence boundaries, wherein defining compares the first set of geofence boundaries to standard map boundaries; displaying an interactive map may comprise the first local map; and displaying a first plurality of pins based on the first plurality of locations on the first local map. Embodiments of this aspect may include corresponding computer systems, apparatus, and computer programs recorded on one or more computer storage devices, each configured to perform the actions of the methods.

Implementations may comprise one or more of the following features. In some embodiments, the geofence boundaries of the first set of geofence boundaries may be based at least in part on city limits of the first plurality of locations. In some aspects, the comparing identifies a proximity between each of the first plurality of locations; and defining a plurality of pin geofence boundaries of the first plurality of pins based on the comparing of the first plurality of locations, wherein the defining occurs where the proximity is less than a predefined threshold distance. In some implementations, a size of each pin may be based on a quantity of the first plurality of locations within each of the plurality of pin geofence boundaries.

In some aspects, defining compares the second set of geofence boundaries to standard map boundaries; defining a third set of geofence boundaries based on comparing the first local map to the second local map identify a second pin area, wherein the third set of geofence boundaries contain both the first set of geofence boundaries and the second set of geofence boundaries; and defining a second local map may comprise at least the third set of geofence boundaries, wherein defining compares the third set of geofence boundaries to standard map boundaries. The method may comprise: displaying a second interactive map may comprise the second local map; and displaying a second plurality of pins based on the first plurality of locations and the second plurality of locations on the second local map.

In some embodiments, the comparing may identify a proximity between each of the first plurality of locations and each of the second plurality of locations; and define a plurality of pin geofence boundaries of the second plurality of pins based on the comparing of the first plurality of locations to the second plurality of locations, wherein the defining occurs where the proximity is less than a predefined threshold distance, and wherein display of the second plurality of pins may comprise a pin for each of the plurality of pin geofence boundaries. A size of each pin is based on a quantity of the first plurality of locations and the second plurality of locations within each of the plurality of pin geofence boundaries. Display of each of the first plurality of pins may be displayed according to at least one of the one or more pin types. The first plurality of sets of pin data further may comprise at least one association. Implementations of the described techniques may include hardware, a method or process, or computer software on a computer-accessible medium.

A system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1A illustrates an exemplary interactive map, according to some embodiments of the present disclosure.

FIG. 1B illustrates an exemplary interactive map, according to some embodiments of the present disclosure.

FIG. 2A illustrates a map segment with exemplary pins and pin areas, according to some embodiments of the present disclosure.

FIG. 2B illustrates a map segment with exemplary pins and pin areas, according to some embodiments of the present disclosure.

FIG. 2C illustrates a map segment with exemplary pins and pin areas, according to some embodiments of the present disclosure.

FIG. 3A illustrates an exemplary embodiment of a local input device, according to some embodiments of the present disclosure.

FIG. 3B illustrates an exemplary embodiment of a local input device, according to some embodiments of the present disclosure.

FIG. 4 illustrates exemplary method steps for interacting with an interactive map.

FIG. 5 illustrates exemplary method steps for providing an interactive map.

FIG. 6 illustrates exemplary method steps for defining a pin area.

FIG. 7 illustrates exemplary method steps for updating an interactive map.

FIG. 8 illustrates exemplary method steps for providing an interactive map.

FIG. 9A illustrates a map segment with exemplary pins and pin areas, according to some embodiments of the present disclosure.

FIG. 9B illustrates a map segment with exemplary pins and pin areas, according to some embodiments of the present disclosure.

FIG. 10 illustrates an exemplary interactive map, according to some embodiments of the present disclosure.

FIG. 11 illustrates an exemplary interactive map configured to interface with an external computing device, according to some embodiments of the present disclosure.

FIG. 12 illustrates an exemplary interactive map, according to some embodiments of the present disclosure.

FIG. 13 illustrates an exemplary interactive map configured to interface with an external computing device, according to some embodiments of the present disclosure.

FIG. 14 illustrates exemplary method steps for a process for providing an interactive map, according to some embodiments of the present disclosure.

FIG. 15 illustrates an exemplary block diagram of an exemplary embodiment of a local input device.

FIG. 16 illustrates an exemplary processing and interface system.

### DETAILED DESCRIPTION

The present disclosure provides generally for a system that collects customer data in a way that creates a shared experience. More specifically, an interactive map for customer engagement is provided. In some embodiments, this information may be displayed at the establishment for other customers to view. This system and method may receive and save addresses to show where customers may originate from. Displaying an interactive map may allow a company to gather data from their customers while engaging the customers in a social sharing platform. This may increase the likelihood that a customer may provide the data and increase a sense of community within a customer pool.

In the following sections, detailed descriptions of examples and methods of the disclosure will be given. The descriptions of both preferred and alternative examples, though thorough, are exemplary only, and it is understood that to those skilled in the art variations, modifications, and alterations may be apparent. It is therefore to be understood that the examples do not limit the broadness of the aspects of the underlying disclosure as defined by the claims.

### Glossary

Pin Type: as used herein refers to an appearance of a pin on an interactive map. In some aspects, the pin type may be different based on predefined parameters. For example, the default pin type may comprise a typical pin shape, and the pin type may comprise a flag for those who indicate they served in the armed forces. In some embodiments, pin types may vary within an association, such as a unique pin type for each branch of the armed forces.
Pin: as used herein refers to a digital geographic indicator. In some aspects, a pin may indicate a precise location. In some embodiments, a pin may indicate a pin area generally, such as in the center of the pin area.
Pin Area: as used herein refers to the geofencing boundaries associated with a pin. In some aspects, a pin area may be based on city limits. In some embodiments, the pin area may vary over time as more pin data may be received and processed.
Pin Data: as used herein refers to any data that may be associated with a pin. In some implementations, pin data may comprise location data, such as a home city. In some embodiments, pin data may include a visit date or other relevant data.
Interactive Map: as used herein refers to a digital display of a geographic region, such as a country, state, or city, as non-limiting examples, wherein the digital display may be modified by users, such as through input of pin data or input of preferences.

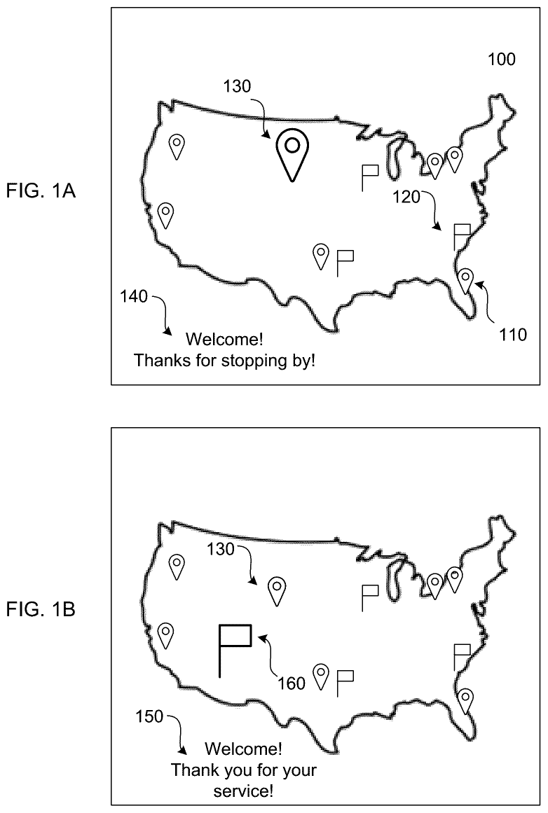

Referring now to FIG. 1A, an exemplary interactive map 100, according to some embodiments of is illustrated. In some aspects, an interactive map 100 may comprise geographic indicators, such as country borders, state lines, or roadways, as non-limiting examples. In some embodiments, the geographic segment displayed in an interactive map 100 may vary based on the needs of a company. For example, if the majority of customers for a company hail from the same state, presenting a single state with pins may create a better sense of community than would showing an entire country with a cluster of pins around the state. As another example, where a company may want to portray themselves as a global corporation, the interactive map may comprise the world, and customers may see where they fit in internationally, which may allow them to feel part of a global community.

In some implementations, an interactive map 100 may contain a plurality of pins 120, 110 based on received pin data. In some embodiments, when a new set of pin data may be received, a new pin 130 may appear on the interactive map 100 and may temporarily appear larger so that a user may be able to see their new pin 130 more easily. In some aspects, the interactive map 100 may present a general welcome message 140 when new pin data may be received.

In some embodiments, a company may be able to customize the interactive map 100, such as by including their logo. In some aspects, the company may be able to control how an interactive map 100 may cycle through information, such as menus, advertisements, or location-specific information. For example, an international company may want to cycle between global, country, and city views. As another example, a company may insert advertising or information throughout the day. In some aspects, nonprofits may be required to keep a donor list posted, which may be integrated with the interactive map 100. The donor list may be cycled through other screens. In some embodiments, the donor list may be integrated directly within the interactive map 100, such as assigning a pin type to donors and indicating where the donors may be from. In some implementations, a user may be able to select from different languages, which may allow for international engagement with the interactive map 100.

Referring now to FIG. 1B, an exemplary interactive map 100, according to some embodiments of the present disclosure, is illustrated. In some embodiments, the new pin 130 may become the same size as the plurality of pins 120, 110 after a predefined amount of time or once new pin data may be received. In some implementations, new pin data may indicate that a user may have an association, such as serving in the armed forces or being part of AARP, and a new flag pin 160 may appear on the interactive map 100. In some aspects, a custom welcome message 150 may be presented based on the association.

In some implementations, a pin size may be based on the number of pin data sets in that location, such as when an amount exceeds a threshold amount. In some embodiments, pins may be grouped based on a threshold distance from a central location, such as a large city or landmark. For example, an Atlanta pin may incorporate regions technically outside of the city limits but still proximate, such as Athens, Duluth, or Marietta. In some aspects, a large central pin may be cleaner than a cluster of small pins around the same area. This may be controllable by user, such as based on preferences, the relative size of the local map, or number of pins in any area. For example, if the entire local map is Atlanta and the nearby areas, a single pin on Atlanta may not be useful, whereas if the entire locale is the United States, then a single pin on Atlanta may be preferred.

In some embodiments, the types of associations that may be collected in the pin data may depend on the company offering the interactive map 100. For example, a children's museum may prompt input of associations that may be interesting to children, such as Girl Scouts, Boy Scouts, or Boys and Girls Club. As another example, an amusement park may want to highlight the frequency of visits for any given user, and the association may be “frequent flier” for those who may have visited the location more than ten times in the past year. As another example, a convention may want to highlight the occupational diversity and prompt input of a user's occupation.

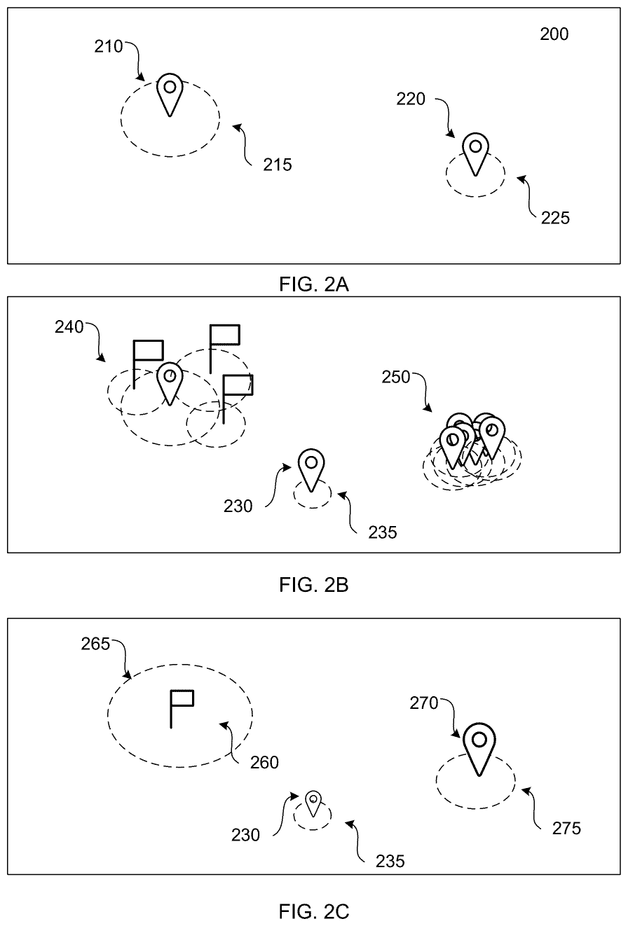

Referring now to FIG. 2A, a map segment with exemplary pins 210, 220 and pin areas 215, 225, according to some embodiments of the present disclosure, is illustrated. In some embodiments, a rural pin 210 may be placed in the middle of a rural city limits pin area 215, and a metropolitan pin 220 may be placed in the middle of a metropolitan city limits pin area 225. In some aspects, a rural city limits pin area 215 may be larger than a metropolitan city limits pin area 225. The city pin area 225 may be smaller with a larger concentration of population, and the rural city limits pin area 225 may be more expansive with a lower concentration of population. In some implementations, the area directly outside the metropolitan city pin area 225 may be suburban towns.

Referring now to FIG. 2B. a map segment with exemplary pins 230 and pin groupings 240, 250, according to some embodiments of the present disclosure, is illustrated. In some aspects, an interactive map 200 may comprise multiple rural pins 240. In some embodiments, a portion of the multiple rural pins 240 may comprise a different pin type, such as flags. In some implementations, a new small town pin 230 may be placed within the small town city limit pin area 235. In some embodiments, a cluster of metropolitan and urban pins 250 may be placed on the interactive map 200.

Referring now to FIG. 2C, a map segment with adjusted pin areas 265, 275, according to some embodiments of the present disclosure, is illustrated. In some aspects, the cluster of metropolitan and urban pins 250 may be combined into a single big city pin 270 and placed in a big city pin area 275. In some embodiments, a big city pin area 275 may encompass the farthest boundaries within the cluster of metropolitan and urban pins 250. In some implementations, the big city pin area 275 may include the original metropolitan city limit pin area 225 and extend a predefined distance beyond it, wherein pins with a pin area that may overlap with that big city pin area 275 nay be grouped with the big city pin 270.

In some aspects, a general rural pin 260 may be placed in a general rural pin area 265. In some embodiments, the general rural pin area 265 may encompass a larger area, such as defined by the borders of multiple rural pins 240. In some implementations, grouping pins and pin areas may allow for easier viewing of an interactive map. For example, the cluster of metropolitan and urban pins 250 may clutter the interactive map without providing more information to a user, whereas a big city pin 270 may provide similar information in a more visually conducive manner.

In some aspects, the adjusted pins may be customized to provide more information. For example, the big city pin 270 may be larger than the small-town pin 230, which may indicate that more users are from the big city pin area 275 than the small town pin area 235. In some implementations, the pin type may be indicative of the majority of users from that area. For example, the majority of users in a general rural pin area 265 may have served in the armed forces, and the representative pin type may be a flag.

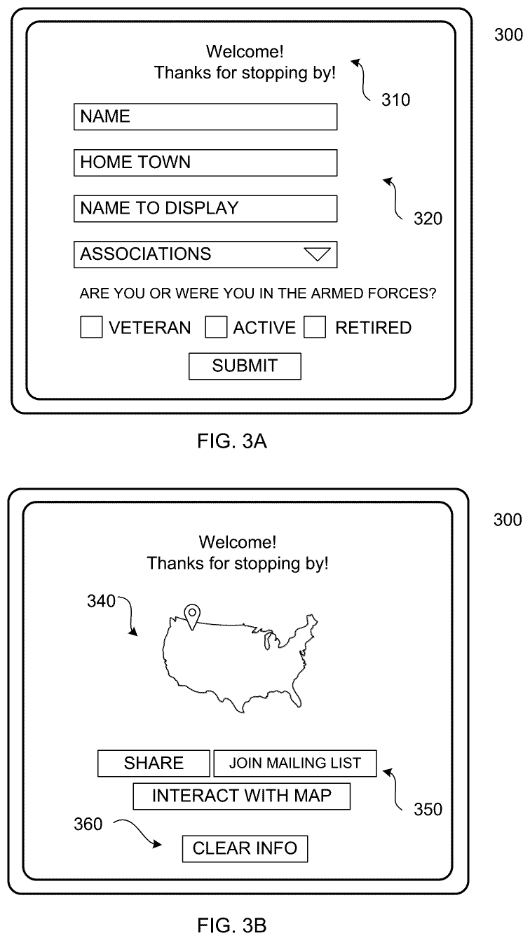

Referring now to FIG. 3A, an exemplary embodiment of a local input device 300, according to some embodiments of the present disclosure, is illustrated. In some aspects, the local input device 300 may prompt for direct input of personal data. In some embodiments, the collected information may comprise pin data 320. In some implementations, not shown, the local input device 300 may collect other personal data, such as contact information, which may allow the company to integrate the customer into their customer management systems.

In some aspects, the local input device 300 may provide a welcome message 310. In some implementations, the local input device 300 may comprise a submit function. In some embodiments, the pin data 320 may include associations in a drop down menu or in a check box format.

Referring now to FIG. 3B, an exemplary embodiment of a local input device 300, according to some embodiments of the present disclosure, is illustrated. In some aspects, a small version of an interactive map 340 may be presented with a pin in the location from the submitted pin data 320. In some embodiments, action prompts 350 may be available to the user. For example, a user may be able to opt in to or opt out of a mailing list or share their pin data, such as through social media platforms. As another example, the user may be able to interact with the interactive map from the local input device 300. In some aspects, the local input device 300 may comprise a portable device, such as a tablet, laptop, or smartphone. In some embodiments, the local input device 300 may comprise a stationary base, such as a kiosk.

In some embodiments, a company may submit some of the personal data to a third party, which may extend the engagement opportunities. For example, the personal data may be sent to a review platform, wherein the user may receive an email prompt to leave a review of the company. In some aspects, the personal data may include a mobile phone number, and the user may be able to opt in to receiving text messages. In some embodiments, the texts may include a version of or a link to an interactive map.

In some implementations, the interface may allow for locations outside the interactive map 340. For example, some interfaces may allow users to select locations outside the interactive map 340. In some embodiments, selected locations outside the interactive map 340 may be treated differently than selections within the boundaries of the interactive map 340. For example, the selections may be treated as discrete selections that may not be grouped.

In some aspects, the user may be able to clear information 360 after input of their personal data. In some embodiments, the local input device 300 may be cleared periodically after a predefined length of inactivity. In some implementations, the personal data may be cleared on the local input device 300 once a user submits their information. Allowing the user to clear information 360 may provide a sense of security so that users that directly follow may not be able to access or view the user's personal data.

In some aspects, the local input device 300 may reassure users that all their personal information is secure within the interface. In some aspects, some interfaces may fully encrypt the input data. In some embodiments, a portion of the personal information may be shared with other non-related third-party outlets. For example, an interface may discretely release area codes, mailing information, and other non-limiting examples, which may provide demographic data without personal identification that may put users on the interface at risk. In some aspects, a portion of the data may be encrypted to limit security risk.

In some embodiments, the local input device 300 may enable the user to enter their location in a free form. For example, the user may enter their area code, state, country, mailing address and other non-limiting examples that may create unique inputs. In some embodiments, a pin system may be used within the interactive map 340 to help narrow down regions or areas if precise addresses are not given.

In some embodiments, different locations may be linked, where pin data may be shared between the locations. For example, users may be incentivized to input their personal data at various locations by a point system, where each log in may give a user points. The points may be redeemable for rewards or badges, which may be shared through one or both the interactive map and social media. In some aspects, the local input device 300 may prompt a “club ID” that may allow the system to access previously submitted personal data. In some embodiments, the local input device 300 may comprise a scanner that may be configured to scan predefined forms of identification, such as passports or driver's licenses, which may allow for easier input of basic personal data.

In some implementations, the system may filter content, such as by removing language deemed inappropriate. For example, as a joke, a user may input a false name with vulgar words, and the system may filter or adjust the input to remove the inappropriate language. In some embodiments, the system may perform an address look up to verify locations. In some implementations, the address look up may be live wherein the user may be prompted to select from a drop down list. In some aspects, a company may customize the inputs, such as whether a location must include an entire address or just the city. In some embodiments, the input parameters may depend on the needs of the company. For example, if the address is to be used for a physical mailing, then the entire address may be useful. As another example, the address may be used to collect demographic data but correspondence may be exclusively electronic, so prompting country, city, and state may be sufficient.

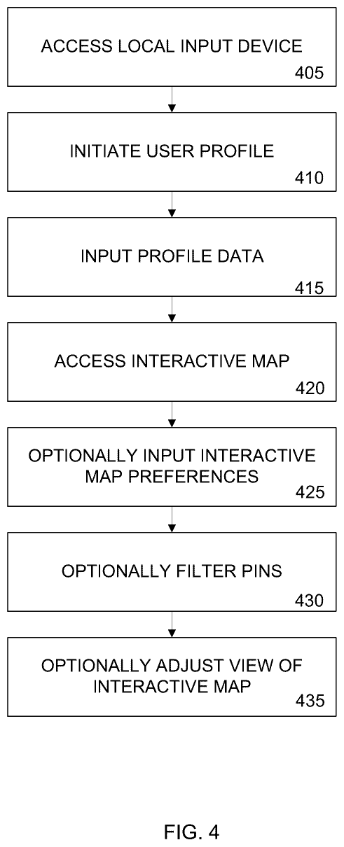

Referring now to FIG. 4, exemplary method steps for interacting with an interactive map, according to some embodiments of the present disclosure, are illustrated. At 405, a local input device may be accessed. At 410, a user profile may be initiated. At 415, profile data may be input. At 420, an interactive map may be accessed. In some embodiments, at 425, interactive map preferences may be input. In some aspects, at 430, pins may be filtered. In some implementations, at 435, a view of the interactive map may be adjusted.

At 410, the interface may provide more informational and unique tooltip prompts for each field within the interface. At 410 and 415, the Tooltips and field headings may be customizable by the user interacting with the interface. In some aspects, there may be a limit at which each field length may be displayed on the interface. In some embodiments, the user may have the option to extend the field length within the interface to allow for greater customization.

In some embodiments, at 420 a company may have its own unique verbiage for their interactive map. In some embodiments, the opt-in and opt-out checkboxes may include a company's unique verbiage as well. For example, one company may have a different overlay on their interactive map than another company based on their respective verbiages used on the checkboxes in the interface. In some implementations, each user for the company may have full control to opt in, opt out, or select neither for their perspective company on the interface.

In some embodiments, if a user opts-out of receiving correspondence, then the system may be prevented from sending an email to that user but does in fact still capture information to display as a pin on the interactive map. In some aspects, if the user opts-in then an email will be sent to them, if and only if, the opt-in checkbox was selected. In some embodiments, if a user does opt-in but changes their mind then an unsubscribe option will be available within the interface.

In some implementations, data from opt-in users may be treated and stored separately. Data collected from users who may not want correspondence may not be stored or registered as discrete information and instead grouped or aggregated. For example, if a user has clicked unsubscribe or opt-out and confirms then they may need to restart the entire process over if they wish to opt back in. In some embodiments, if the user selects unsubscribe then an initial email will be sent and from there additional information may not be downloaded from the database.

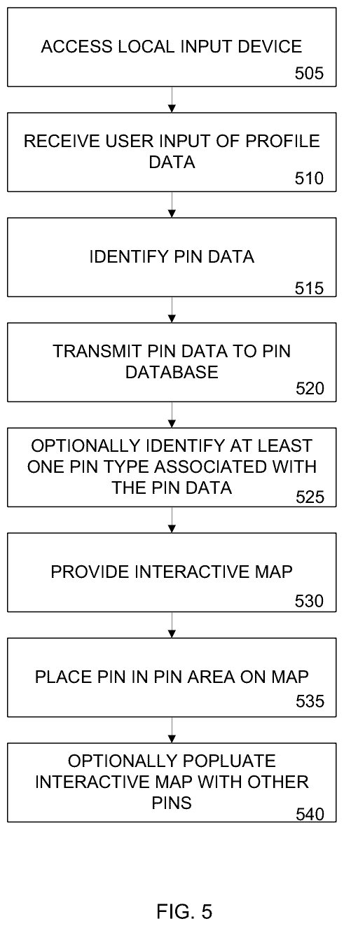

Referring now to FIG. 5, exemplary method steps for providing an interactive map, according to some embodiments of the present disclosure, are illustrated. At 505, a local input device may be accessed. At 510, a user input of profile data may be received. At 515, pin data may be identified. At 520, pin data may be transmitted to a pin database. In some embodiments, at 525, at least one pin type may be associated with the pin data. At 530, an interactive map may be provided. At 535, a pin may be placed in the pin area of an interactive map. In some implementations, at 540, other pins may be populated on the interactive map.

In some implementations, additional filters may be added to export information. In some aspects, the filters may allow for additional customization of information and added categories to make pins more unique and users easier to distinguish. In some aspects, the filters may include date range, military association, opt-in or opt-out options, and other non-limiting examples. In some aspects, accessibility may be key when it comes to multi-ownership based on preferences. In some embodiments, the extra filters may help distinguish between multiple users on the same interactive map or pin, with similar names, and other non-limiting examples.

In some embodiments, each party or entity may have the ability to share different threads or extensions of information based on their filters and preferences as well. In some implementations, a party may refuse to share some information but include other information. For example, the user may refrain from sharing their mailing address and zip code but give the state in which they live in. In some aspects, the user may enable all of their information to be shared on the interface and have no preference to which is withheld.

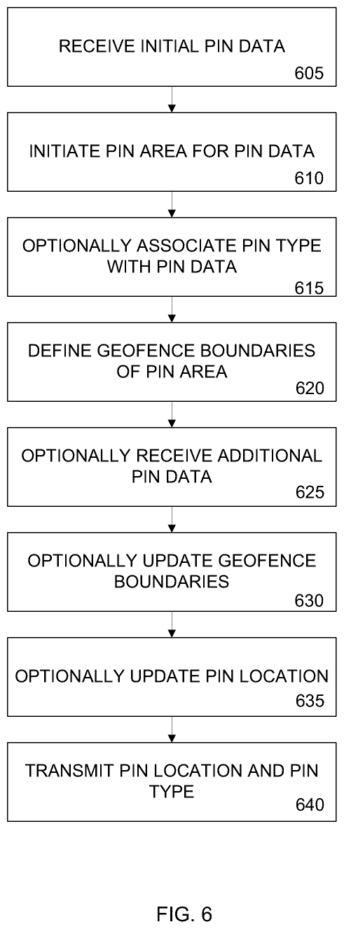

Referring now to FIG. 6, exemplary method steps for defining a pin area, according to some embodiments of the present disclosure, are illustrated. At 605, initial pin data may be received. At 610, a pin area for pin data may be initiated. In some aspects, at 615, a pin type may be associated with pin data. At 620, geofence boundaries of a pin area may be defined. In some implementations, at 625, additional pin data may be received. In some embodiments, at 630, geofence boundaries may be updated. In some aspects, at 635, a pin location may be updated. At 640, a pin location and pin type may be may transmitted. In some implementations, multiple pin data may be received, such as where multiple users may simultaneously access the display. Where multiple pin data may be received, the system may collect the pin data in parallel and prioritize complete pin data to populate the display map.

In some embodiments, a set or sets of pin data may be received, such as from a group of people. In some aspects, the system may be set to group received pin data by threshold amounts or parameters, such as by date. In some implementations, geofence boundaries of each pin data may be defined, such as by city limits, jurisdictional boundaries, zip codes, area codes, regions, or neighborhoods. In some embodiments, the geofence boundaries of the set or sets of pin data may determine the displayed “local” map, wherein the local geofence boundaries may be based on the individual geofence boundaries of the pin data.

For example, locations in sets of pin data may only include Florida cities, and the local geofence boundaries may comprise the state lines of Florida. If another set of pin data includes a location outside of Florida, the local map display may change to include the new location. In some aspects, a local map may be manually selected. In some embodiments, a user may input a location or click an area on the display map, and the local map may adjust to geofence boundaries for that manually selected area. The local map may display pins within that selected area. For example, a user may click on Houston, and the local map may comprise the city limits of Houston, or if there are nearby pin locations, the local map may comprise Houston and its nearby cities.

In some embodiments, the local map may depend on how many pins may be located in the area. For example, a user may select Macon, Georgia, which is somewhat near Atlanta. There may not be many pins within the city limits of Macon, so the local map may include Atlanta or Savannah to show a meaningful display.

In some implementations, the interface may allow users to attach their entry to a category. In some aspects, a company may add icons that allow users to select which category they would like to attach their entry to. In some embodiments, this may be an optional feature within certain companies or interfaces. In some implementations, the different icons may be downloaded to different customers within the interface based on their preferences and needs. In some embodiments, the multiple categories may be selected per pin/icon depending on what the company or user decides. For example, the company may select the category “Olympics” and the subcategories may include 100 meter, high jump, or javelin throw, where users may be able to self-identify as a fan or participant in each sport by selecting the subcategory icon display. In some embodiments, the icon may appear next to the username on the map.

In some aspects, if the category or association is military involvement they may have unique icon next to their name along with the flag of where they are stationed or what country they are serving. In some embodiments, the user may override their default flag with another if they choose to with an override specifically for military personnel. In some implementations, the flag or icon next to their name may come with a unique military pin that identifies them as military personnel.

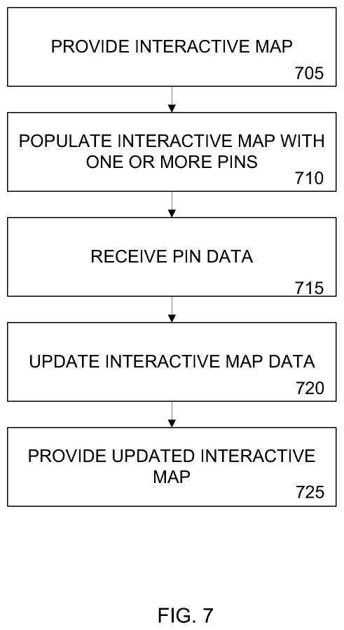

Referring now to FIG. 7, exemplary method steps for updating an interactive map, according to some embodiments of the present disclosure, are illustrated. At 705, an interactive map may be provided. At 710, an interactive map may be populated with one or more pins. At 715, pin data may be received. At 720, interactive map data may be updated. At 725, an updated interactive map may be provided.

In some non-limiting exemplary embodiments, pin data may be received from and one or more portions of an interactive map may be provided via a plurality of devices. In some implementations, pin data received from any of the device(s) may cause the relevant portion(s) of the interactive map to be updated upon all of the devices when displayed. In some aspects, the relevant portion(s) of the interactive map may be updated in substantially real time.

In some implementations, the interactive map may display advertisements throughout the pins and different interactive aspects. In some aspects, companies may display any amount of advertisements they want across their interface. In some embodiments, companies may display a limited number of advertisements at once, such as based on space, subscription level, or preferences. For example, a company may list up to twenty advertisements on their interactive map. In some embodiments, the ads may be continuously looped on the interface in the order in which they are entered by the company.

In some implementations, a user may set up the amount of time they wish for each advertisement to loop of advertisement. In some embodiments, the user may have full control over the quality and type of content each of the advertisements on the interface has. In some embodiments, the user may add and delete any content or advertisement that is displayed on the interface. For example, some advertisements may be seasonal, and the user may then control the times in which the advertisement is displayed throughout the year. In some embodiments, the user may control what times of day each advertisement comes on the interface, or at days of the week certain advertisements play.

In some implementations, the user may have control of special announcements that are displayed throughout the interface. In some embodiments, this system may work like the advertisement system in which the user may have full control over when and how the announcements are played on the interface. In some implementations, the user may control audio to the announcements at a desired level and speed. In some aspects, the user may link the interface and interactive map to social media platforms to help grow network and for larger access to audio and video and other forms of entertainment on the interface.

For example, the interface may connect to social media or media sharing platforms to play clips for advertisements or show does of relevant announcements on the interface. In some aspects, the user may control the size of the media on the interface. For example, they may make the media full screen for an important announcement. In some embodiments, the user may control the length of the media and the duration it may stay full screen on the interface.

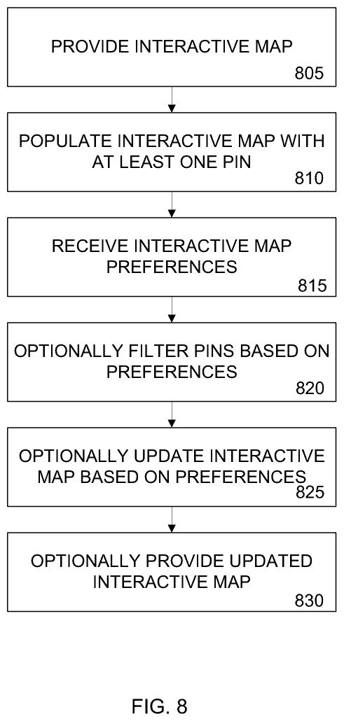

Referring now to FIG. 8, exemplary method steps for providing an interactive map, according to some embodiments of the present disclosure, are illustrated. At 805, an interactive map may be provided. At 810, an interactive map may be populated with at least one pin. At 815, interactive map preferences may be received. In some embodiments, at 820, pins may be filtered based on preferences. In some aspects, at 825, an interactive map may be updated based on preferences. In some implementations, at 830, an updated interactive map may be provided. In some embodiments, preferences and filtering abilities may include metadata associated with pin data, such as date and time of input.

In some aspects, the interface may be coded to run a small dedication external computer running native software. In some embodiments, the interface may have the ability to have multiple displays and sign-in tablets at one location to share and display multiple pins. In some implementations, the interactive map may have a built-in restart display to clear all ram, cache, and cookies to optimize performance.

In some implementations, unattended access of the external computer may use troubleshooting and maintenance using a remote access system. In some embodiments, the interface may be used on tablets for sign in purposes, remote programming, kiosk lockout, and ease of setup by using a premade template. For example, a mobile tablet may be used to navigate the interface as a consumer and edit the interface as a user. In some aspects, the tablet may be used to connect to a television for a larger display screen when displaying in front of larger audiences.

In some embodiments, connecting to a larger display may help the tablet connect to an uninterrupted power supply. In some embodiments, the interface may display on the larger display screen, even when the tablet may be asleep or locked. For example, advertisements, media and other monetized interface media may automatically play on a larger display screen despite the tablet being locked.

For example, a company may be open from 8 am to 10 pm. Pin data may be collected throughout the day, and metadata may be collected along with the pin data. Preferences may allow a user to view day pins separately from night pins.

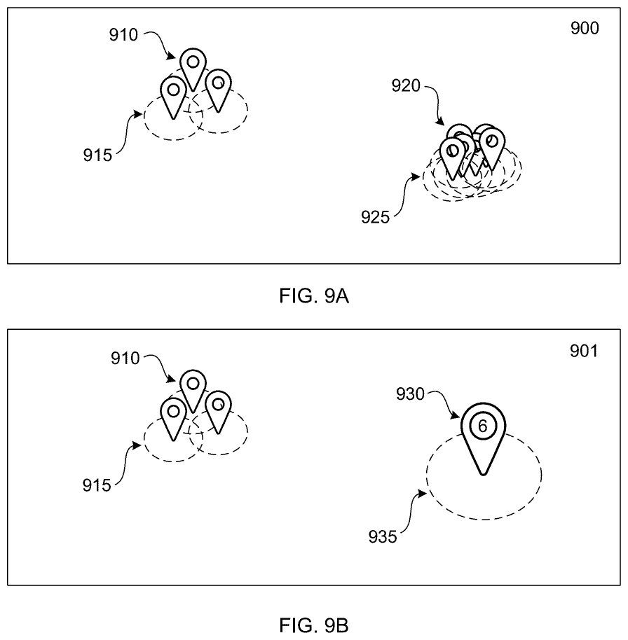

Referring now to FIGS. 9A-9B, segments of an interactive map 900, 901 with exemplary pins 910, 920, 930 and pin areas 915, 925, 935 according to some embodiments of the present disclosure, are illustrated. In some aspects, the interactive map 900 may comprise a plurality of pins 910, 920 in close proximity to each other, which may make the interactive map 900 appear cluttered, thereby detracting from the aesthetic quality of the interactive map 900 and making it difficult for users to see each individual pin 910, 920. In some implementations, the interactive map 901 may be configured to consolidate a grouping of pins 920 into a single cluster pin 930. In some embodiments, each cluster pin 930 may represent a plurality of pins 920.

In some non-limiting exemplary implementations, the interactive map 901 may be configured to convert a plurality of pins 920 into one or more cluster pins 930 based at least partially on one or more of: a proximity and a density of pins 920, or any similar parameters, either predetermined or dynamically set by a user. By way of example and not limitation, the interactive map 901 may be configured to consolidate four or more pins within a two mile radius into a single cluster pin 930. In some aspects, each cluster pin 930 may be larger than each individual pin 920 to provide a visual indication that the cluster pin 930 represents multiple pins 920. In some non-limiting exemplary embodiments, each cluster pin 930 may indicate the number of individual pins 920 it represents. By way of example and not limitation, if a cluster pin 930 represents six individual pins 920, then a portion of the cluster pin 930 may comprise the number “6.”

In some aspects, the pin area 935 of a cluster pin 930 may be greater than the pin area 925 of each individual pin 920 represented by the cluster pin 930. In some non-limiting exemplary embodiments, the pin area 935 of the cluster pin 930 may comprise the combined pin areas 925 of the represented pins 920, or some proportional representation thereof. By way of example and not limitation, a cluster pin 930 that represents ten individual pins 920 within a five mile radius of each other may comprise a larger pin area 935 than a cluster pin 930 that represents four pins 920 within a one mile radius of each other. In some aspects, the geofence boundaries of the pin area 935 of a cluster pin 930 may comprise the outermost geofence boundaries of the pin areas 925 of the pins 920 represented by the cluster pin 930.

In some implementations, the interactive map 901 may be configured to automatically consolidate a grouping of pins 920 based on one or more predefined rules or parameters, such as proximity distance and/or density, as non-limiting examples. In some embodiments, a user may use at least one input device to instruct the interactive map to consolidate one or more groupings of pins 920 as desired in an ad hoc or on-demand manner based on user preference.

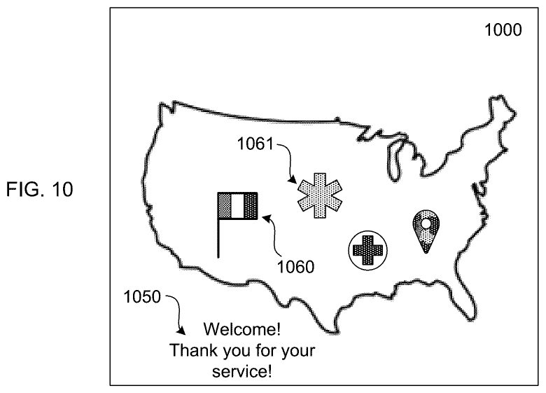

Referring now to FIG. 10, an exemplary interactive map 1000, according to some embodiments of the present disclosure, is illustrated. In some aspects, the interactive map 1000 may receive one or more sets of pin data indicating that a user may have an association, such as being a current or veteran member of the armed forces of at least one country or a first responder, as non-limiting examples. In some implementations, the interactive map 1000 may be configured to generate a new flag pin 1060 or symbolic pin 1061 to represent the user's association or membership. By way of example and not limitation, a flag pin 1060 may represent a country that a user is from and/or for which the user has served in a military capacity, and a symbolic pin 1061 may represent a user's association with a particular military branch (such as, for example and not limitation, the United States Army, Navy, Air Force, or Marines) or a fire or police department or an emergency medical services (“EMS”) provider, as non-limiting examples. In some non-limiting exemplary embodiments, a symbolic pin 1061 may be combined with a flag pin 1060 such that the flag pin 1060 may comprise at least one symbol. In some aspects, a custom welcome message 1050 may be presented based on the user's identified association.

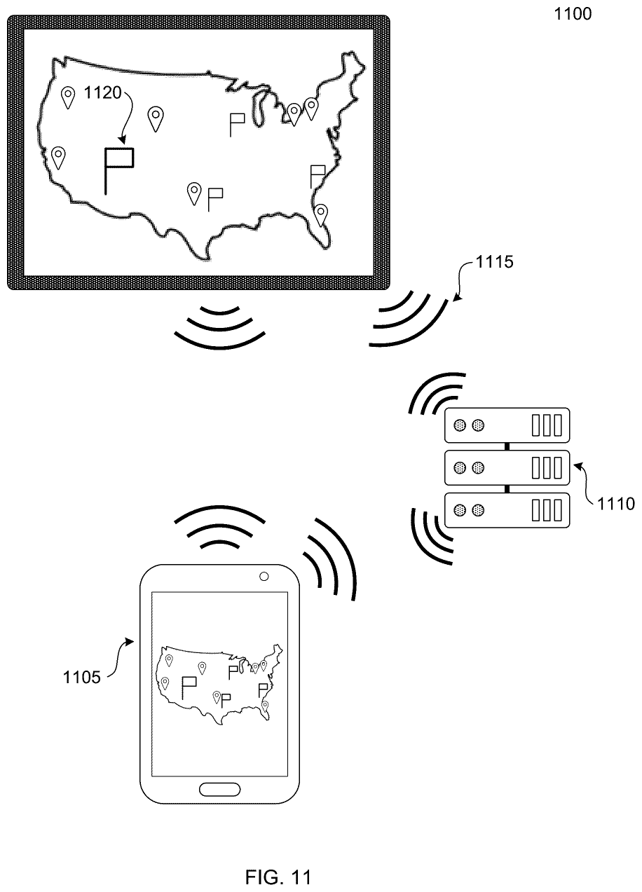

Referring now to FIG. 11, an exemplary interactive map 1100 configured to interface with an external computing device 1105, according to some embodiments of the present disclosure, is illustrated. In some aspects, the interactive map 1100 may be configured at a host location, such as, for example and not limitation, a business, establishment, enterprise, organization, or commercial entity, and the interactive map 1100 may be communicatively coupled to at least one external computing device 1105 via one or more servers 1110 using at least one network connection 1115, such as, for example and not limitation, a connection to the global, public Internet, a local area network (“LAN”), or a cellular network, as non-limiting examples. In some embodiments, the external computing device 1105 may comprise at least one storage medium and at least one processing device, wherein the storage medium may comprise one or more coded instructions or algorithms that may be accessed and executed by the processing device to enable the processing device to receive at least one portion of the interactive map 1100 transmitted from the interactive map 1100 at the host location and display the portion(s) of the interactive map 1100 upon at least one display screen.

In some implementations, at least one portion of the interactive map 1100 may be displayed via at least one display screen integrated with or communicatively coupled to the external computing device 1105. In some embodiments, the portion(s) of the interactive map 1100 displayed via the external computing device 1105 may comprise a simplified and/or condensed format to minimize the amount of data required to be transmitted between the external computing device 1105 and the interactive map 1100 and/or to facilitate viewing of the interactive map 1100 in a mobile and/or compact configuration. By way of example and not limitation, one or more features of the interactive map 1100 may be disabled when displayed on the external computing device 1105, such as rotation of the orientation of the interactive map 1100 or the display of multiple side-by-side map portions, as non-limiting examples. In some aspects, the external computing device 1105 may comprise at least one of: a smartphone, a tablet computer, a laptop computer, a desktop computer, a gaming console, a smart television, or a wearable technology device, such as a smart watch, as non-limiting examples.

In some embodiments, the portion of the interactive map 1100 displayed on the external computing device 1105 may comprise a close-up or “zoomed in” view of a local map of a community, such as a city, town, county, or neighborhood, as non-limiting examples. In some non-limiting exemplary implementations, the portion of the interactive map 1100 displayed on the external computing device 1105 may comprise one or more pins 1120 that may be relevant or pertinent to one or more business, hospitality, recreational, charitable, or emergency endeavors, wherein one or more of the pins 1120 may be indicative of one or more locations in need of work, assistance, or other attention.

As a non-limiting illustrative example, a restoration company may be tasked with rebuilding multiple sections of a community after a major storm passes through. In some aspects, one or more pins 1120 may be displayed on an interactive map 1100 configured at a central location, as well as one or more portions of the interactive map displayed on the external computing devices 1105 used by field workers and crew members, to identify where buildings are located that experienced fire damage, flood damage, or wind damage, as non-limiting examples, so that the restoration company may allocate the appropriate resources to the relevant locations in a timely and efficient manner. In some implementations, field workers or other users may use at least one input device (such as, for example and not limitation, a keyboard, keypad, touchscreen, pointing device, microphone, camera, motion detector, accelerometer, or biometric scanner) integrated with or communicatively coupled to the external computing device 1105 to enter one or more sets of pin data while in the community to identify the type of damage observed, wherein the new pin data may be transmitted to the interactive map 1100 at the host location to generate a pin 1120 on the interactive map 1100 that indicates the type of damage observed at the pinned location.

By way of example and not limitation, a pin 1120 may comprise a picture of flames to indicate fire damage or a picture of water to indicate flood damage, as non-limiting examples. In some embodiments, a single location may be marked with multiple types of damage pins 1120, such as, for example and not limitation, when a single location may experience both wind and flood damage. In some implementations, any changes made to the interactive map 1100 using one device may cause the relevant portion(s) of the interactive map 1100 to be updated when displayed on any other device(s). In some embodiments, such changes may be implemented in substantially real time.

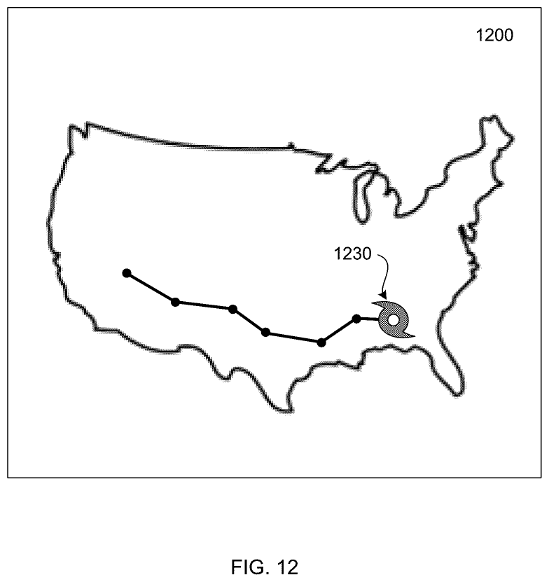

Referring now to FIG. 12, an exemplary interactive map 1200, according to some embodiments of the present disclosure, is illustrated. In some aspects, the interactive map 1200 may be configured to receive and display one or more types of data from one or more third-party databases or other sources, wherein the data may be overlaid or otherwise displayed upon one or more portions of the interactive map 1200 to add to the utility of the interactive map 1200.

By way of example and not limitation, the interactive map 1200 may be overlaid with weather or storm data transmitted and received from one or more third-party meteorology sources via one or more servers or databases communicatively coupled to the interactive map 1200 via at least one network connection, such as, for example and not limitation, a connection to the global, public Internet, a local area network (“LAN”), or a cellular network, as non-limiting examples. In some implementations, the overlaid data may be retrieved and displayed upon the interactive map 1200 in substantially real time.

As a non-limiting illustrative example, a restoration company may use the interactive map 1200 to track the path of a severe storm 1230 as the storm 1230 moves through a local community. In some aspects, the ability to track the storm 1230 may allow the restoration company to accurately pin locations that may be most likely to receive one or more types of damage, such that those locations may be inspected first for potential restoration work after the storm passes.

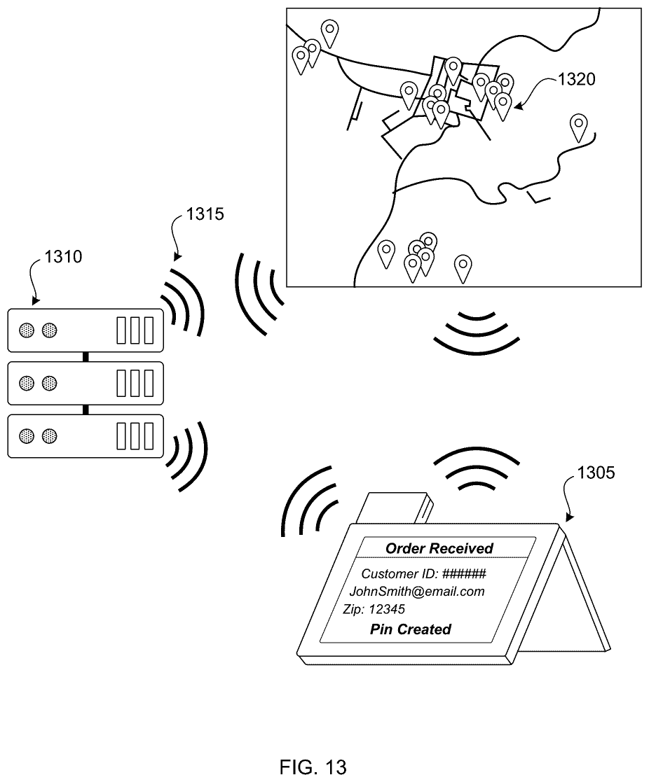

Referring now to FIG. 13, an exemplary interactive map 1300 configured to interface with an external computing device configured 1305, according to some embodiments of the present disclosure, is illustrated. In some aspects, the interactive map 1300 may be communicatively coupled to one or more point-of-sale devices, systems, or similar electronic external computing terminals or devices 1305 via one or more servers 1310 and at least one network connection 1315.

In some implementations, a business, establishment, enterprise, organization, or similar entity may electronically and/or logically connect one or more external computing devices 1305 to the interactive map 1300 using one or more application programming interfaces (“APIs”) such that data comprising one or more types of user data or information pertaining to one or more customers, clients, patrons, or visitors collected or received via the external computing device(s) 1305 may be used to identify or generate one or more sets of new pin data and create one or more pins 1320 that may be transmitted to and displayed upon the interactive map 1300. In some embodiments, the pins 1320 may be generated and displayed in substantially real time upon receiving the real-time transmission of relevant user data.

As a non-limiting illustrative example, a user comprising a food truck operator may use the interactive map 1300 to develop an understanding of where the patrons of the food truck reside. In some aspects, the transitory nature of the food truck and the brief nature of the interaction between the food truck and each patron may make it difficult to successfully compel patrons to enter pin data on the interactive map 1300. In some implementations, the food truck operator may communicatively couple the food truck's point-of-sale device 1305 to the interactive map 1300 using an API, such that the email address and zip code of each patron completing a transaction with the food truck via the point-of-sale device 1305 may be retrieved and used to generate new pin data for one or more pins 1320 that may be displayed via the interactive map 1300.

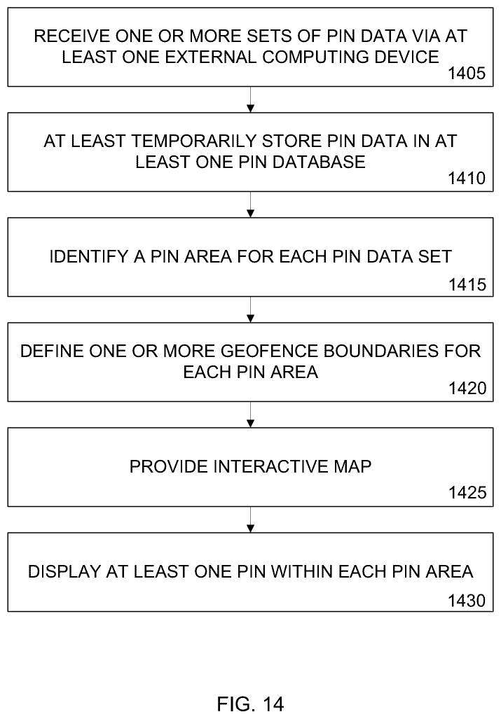

Referring now to FIG. 14, exemplary method steps for a process 1400 for providing an interactive map, according to some embodiments of the present disclosure, are illustrated. In some aspects, at 1405, one or more sets of pin data may be received via at least one external computing device. In some non-limiting exemplary embodiments, the at least one external computing device may comprise a point-of sale terminal, device, or system.

By way of example and not limitation, one or more sets of pin data may be identified and/or extracted from an amount of user data received by the point-of-sale device when a customer, client, patron, or similar user completes a purchase or similar financial transaction using the point-of-sale device, or otherwise enters one or more types of personal or identification data using an external computing device associated with at least one business, enterprise, organization, company, or group. In some implementations, at least one application programming interface may be used to help identify and extract one or more sets of pin data associated with the user's interaction with the external computing device, such as, for example and not limitation, an email address and a zip code associated with the user's residential location.

In some embodiments, at 1410, the set(s) of pin data may be at least temporarily stored within at least one pin database or similar storage medium. In some implementations, at 1415. a pin area may be identified for each received set of pin data. In some aspects, at 1420, one or more geofence boundaries may be defined for each pin area. In some implementations, at 1425, an interactive map may be provided and, in some aspects, at 1430 at least one pin may be displayed within each pin area.

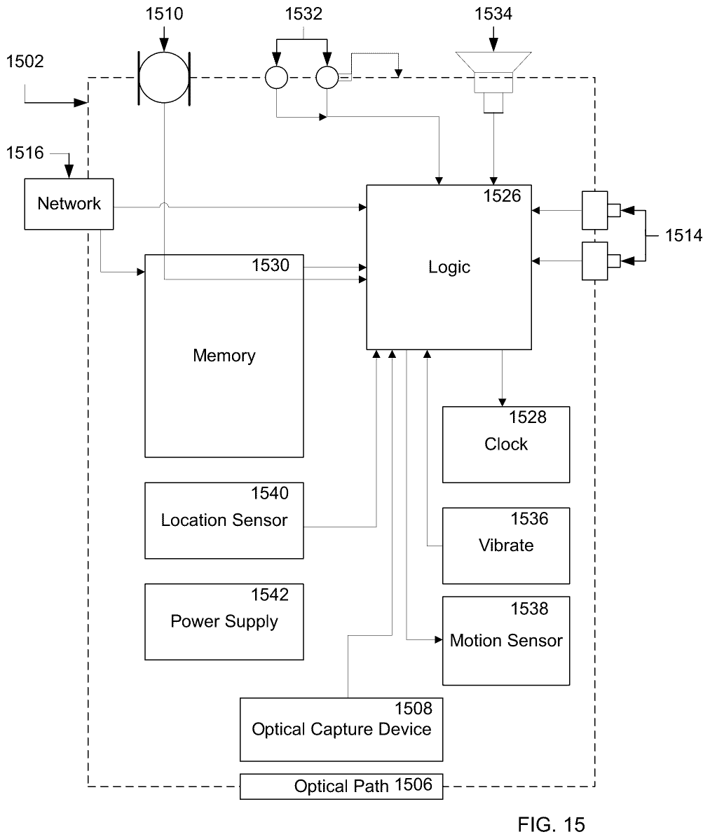

Referring now to FIG. 15, an exemplary block diagram of an exemplary embodiment of a local input device 1502 is illustrated. The mobile device 1502 may comprise an optical capture device 1508, which may capture an image and convert it to machine-compatible data, and an optical path 1506, typically a lens, an aperture, or an image conduit to convey the image from the rendered document to the optical capture device 1508. The optical capture device 1508 may incorporate a Charge-Coupled Device (CCD), a Complementary Metal Oxide Semiconductor (CMOS) imaging device, or an optical sensor of another type.

In some embodiments, the mobile device 1502 may comprise a microphone 1510, wherein the microphone 1510 and associated circuitry may convert the sound of the environment, including spoken words, into machine-compatible signals. Input facilities 1514 may exist in the form of buttons, scroll-wheels, or other tactile sensors such as touchpads. In some embodiments, input facilities 1514 may include a touchscreen display. Visual feedback 1532 to the user may occur through a visual display, touchscreen display, or indicator lights. Audible feedback 1534 may be transmitted through a loudspeaker or other audio transducer. Tactile feedback may be provided through a vibration module 1536.

In some aspects, the mobile device 1502 may comprise a motion sensor 1538, wherein the motion sensor 1538 and associated circuity may convert the motion of the mobile device 1502 into machine-compatible signals. For example, the motion sensor 1538 may comprise an accelerometer, which may be used to sense measurable physical acceleration, orientation, vibration, and other movements. In some embodiments, the motion sensor 1538 may comprise a gyroscope or other device to sense different motions.

In some implementations, the mobile device 1502 may comprise a location sensor 1540, wherein the location sensor 1540 and associated circuitry may be used to determine the location of the device. The location sensor 1540 may detect Global Position System (GPS) radio signals from satellites or may also use assisted GPS where the mobile device may use a cellular network to decrease the time necessary to determine location. In some embodiments, the location sensor 1540 may use radio waves to determine the distance from known radio sources such as cellular towers to determine the location of the mobile device 1502. In some embodiments these radio signals may be used in addition to and/or in conjunction with GPS.

In some aspects, the mobile device 1502 may comprise a logic module 1526, which may place the components of the mobile device 1502 into electrical and logical communication. The electrical and logical communication may allow the components to interact. In some embodiments, the received signals from the components may be processed into different formats and/or interpretations to allow for the logical communication. The logic module 1526 may be operable to read and write data and program instructions stored in associated storage 1530, such as RAM, ROM, flash, or other suitable memory. In some aspects, the logic module 1526 may read a time signal from the clock unit 1528. In some implementations, the mobile device 1502 may comprise an on-board power supply 1542. In some embodiments, the mobile device 1502 may be powered from a tethered connection to another device, such as a Universal Serial Bus (USB) connection.

In some implementations, the mobile device 1502 may comprise a network interface 1516, which may allow the mobile device 1502 to communicate and/or receive data to a network and/or an associated computing device. The network interface 1516 may provide two-way data communication. For example, the network interface 1516 may operate according to an internet protocol. As another example, the network interface 1516 may comprise a local area network (LAN) card, which may allow a data communication connection to a compatible LAN. As another example, the network interface 1516 may comprise a cellular antenna and associated circuitry, which may allow the mobile device to communicate over standard wireless data communication networks. In some implementations, the network interface 1516 may comprise a Universal Serial Bus (USB) to supply power or transmit data. In some embodiments, other wireless links known to those skilled in the art may also be implemented.

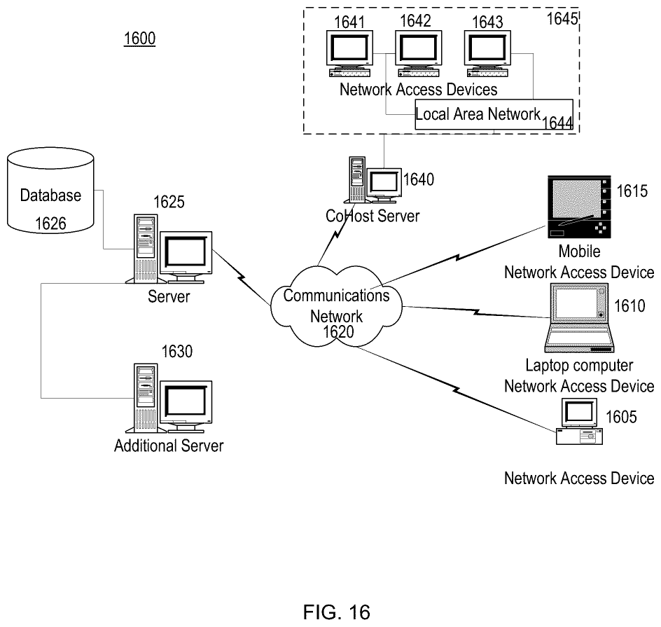

Referring now to FIG. 16, an exemplary processing and interface system 1600 is illustrated. In some aspects, access devices 1615, 1610, 1605, such as a paired portable device 1615 or laptop computer 1610 may be able to communicate with an external server 1625 though a communications network 1620. The external server 1625 may be in logical communication with a database 1626, which may comprise data related to identification information and associated profile information. In some embodiments, the server 1625 may be in logical communication with an additional server 1630, which may comprise supplemental processing capabilities.

In some aspects, the server 1625 and access devices 1605, 1610, 1615 may be able to communicate with a cohost server 1640 through a communications network 1620. The cohost server 1640 may be in logical communication with an internal network 1645 comprising network access devices 1641, 1642, 1643 and a local area network 1644. For example, the cohost server 1640 may comprise a payment service, such as PayPal or a social network, such as Facebook or a dating website.

### Conclusion

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A system for providing an interactive map, wherein the system comprises:
a display;
one or more local input interfaces;
one or more memory resources comprising:
a user profile database;
one or more processors in communication with the display, one or more local input interfaces, and the one or more memory resources, wherein the one or more processors are configured to:
receive one or more of sets of pin data, wherein each of the one or more sets of pin data comprises at least one location;
identify a pin area for each of the one or more sets of pin data;
define one or more geofence boundaries based on each pin area;
display an interactive map on the display; and
display at least one pin within the pin area of each of the one or more sets of pin data on the interactive map; and
at least one external computing device communicatively coupled to the one or more processors, wherein the at least one external computing device comprises at least one input device, at least one storage medium, and at least one processing device, wherein the at least one storage medium comprises one or more coded instructions that enable the at least one processing device to:
receive at least a portion of the one or more sets of pin data; and
transmit the at least a portion of the one or more sets of pin data to the one or more processors.

2. The system of claim 1, wherein the one or more processors are further configured to:
transmit at least one portion of the interactive map to the at least one external computing device.

3. The system of claim 2, wherein the at least one external computing device further comprises at least one display screen, wherein the one or more coded instructions enable the at least one processing device of the at least one external computing device to:
receive the at least one portion of the interactive map transmitted from the one or more processors; and
display the at least one portion of the interactive map upon the at least one display screen.

4. The system of claim 3, wherein the at least one external computing device comprises a mobile computing device.

5. The system of claim 1, wherein the at least a portion of the one or more sets of pin data is transmitted in real time.

6. The system of claim 5, wherein each of the at least one pin is displayed in real time.

7. The system of claim 1, further comprising at least one third-party database communicatively coupled to the one or more processors, wherein the at least one third-party database comprises data that may be received by the one or more processors and displayed upon one or more portions of the interactive map.

8. The system of claim 1, wherein the at least one external computing device is communicatively coupled to the one or more processors via at least one application programming interface.

9. The system of claim 8, wherein the at least one external computing device comprises a point-of-sale device.

10. The system of claim 9, wherein the at least a portion of the one or more sets of pin data is identified from an amount of user data received via at least one financial transaction.

11. The system of claim 10, wherein the at least one financial transaction comprises a purchase facilitated by the point-of-sale device.

12. A method for displaying an interactive map comprising:
receiving one or more of sets of pin data, wherein each of the one or more sets of pin data comprises at least one location;
identifying a pin area for each of the one or more sets of pin data;
defining one or more geofence boundaries based on each pin area;
displaying an interactive map;
displaying at least one pin within the pin area of each of the one or more sets of pin data on the interactive map; and
receiving at least a portion of the one or more sets of pin data via at least one external computing device.

13. The method of claim 12, further comprising:
transmitting at least one portion of the interactive map to the at least one external computing device;
receiving the at least one portion of the interactive map at the at least one external computing device; and
displaying the at least one portion of the interactive map upon at least one display screen of the at least one external computing device.

14. The method of claim 13, wherein the at least one external computing device comprises a mobile computing device.

15. The method of claim 12, wherein the at least a portion of the one or more sets of pin data is received in real time.

16. The method of claim 15, wherein each of the at least one pin is displayed in real time.

17. The method of claim 12, further comprising.
receiving an amount of data from at least one third-party database; and
displaying at least a portion of the amount of data upon at least one portion of the interactive map.

18. The method of claim 12, wherein the at least one external computing device comprises a point-of-sale device.

19. The method of claim 18, wherein the at least a portion of the one or more sets of pin data is identified from an amount of user data received via at least one financial transaction.

20. The method of claim 19, wherein the at least one financial transaction comprises a purchase facilitated by the point-of-sale device.
